(19) United States
(12) Patent Application Publication
(10) Pub. No.: US 2023/0063655 A1
(43) Pub. Date: Mar. 2, 2023

(54) SYSTEMS AND METHODS FOR HIGH MOISTURE EXTRUSION OF BACTERIAL PROTEINS FOR MEAT ANALOG FOOD PRODUCTS

(71) Applicant: The Livekindly Company Switzerland GmbH, Pfäffikon (CH)

(72) Inventor: Julie Daoust, Los Angeles, CA (US)

(21) Appl. No.: 17/459,426

(22) Filed: Aug. 27, 2021

(51) Int. Cl. A23J 3/26; A23J 3/22; A23J 3/20; A23P 30/20

(52) U.S. Cl. CPC A23J 3/26; A23J 3/227; A23J 3/20; A23P 30/20

(57) ABSTRACT

Embodiments of the present disclosure may include a system for high moisture extrusion (HME) of bacterial proteins to make meat analog food products, the system including a high moisture extrusion (HME) system including using an automatic and dynamic bacterial proteins high moisture extrusion (HME) feedback loop for controlling output conditions of a bacterial protein meat analog food product, the high moisture extrusion (HME) system including a dry feed system, the dry feed system feeding bacterial proteins into the high moisture extrusion (HME) system at a baseline bacterial proteins dry feed rate. Embodiments may also include a water feed system, the water feed system feeding water into the high moisture extrusion (HME) system at a baseline water feed rate. Embodiments may also include a barrel system, the barrel system including a shaft moving at a baseline shaft speed. Embodiments may also include at least one screw controlled by the shaft.

### FIELD OF TECHNOLOGY

Embodiments of the present disclosure are directed to systems and methods for high moisture extrusion (HME) of bacterial proteins to make meat analog food products, and more particularly, not by limitation, including using an automatic and dynamic bacterial proteins high moisture extrusion (HME) feedback loop for controlling output conditions of a bacterial protein meat analog food product.

### SUMMARY

Embodiments of the present disclosure may include a system for high moisture extrusion (HME) of bacterial proteins to make meat analog food products, the system including a high moisture extrusion (HME) system including using an automatic and dynamic bacterial proteins high moisture extrusion (HME) feedback loop for controlling output conditions of a bacterial protein meat analog food product, the high moisture extrusion (HME) system including a dry feed system, the dry feed system feeding bacterial proteins into the high moisture extrusion (HME) system at a baseline bacterial proteins dry feed rate.

Embodiments may also include a water feed system, the water feed system feeding water into the high moisture extrusion (HME) system at a baseline water feed rate. Embodiments may also include a barrel system, the barrel system including a shaft moving at a baseline shaft speed. Embodiments may also include at least one screw controlled by the shaft. Embodiments may also include a heating system. Embodiments may also include a cooling die, the cooling die being maintained at a baseline cooling die temperature by the heating system. Embodiments may also include an electronic sensor system, the electronic sensor system electronically connected to the dry feed system, the water feed system, the barrel system, and the cooling die. Embodiments may also include a main operation panel, the main operation panel being electronically connected to the electronic sensor system, the main operation panel including at least one processor. Embodiments may also include a memory storing processor-executable instructions. In some embodiments, the at least one processor is configured to implement the following operations for the automatic and dynamic bacterial proteins high moisture extrusion (HME) feedback loop upon executing the processor-executable instructions, automatically sensing the baseline bacterial proteins dry feed rate of the bacterial proteins using the electronic sensor system. Embodiments may also include automatically sensing the baseline water feed rate using the electronic sensor system. Embodiments may also include automatically sensing the baseline shaft speed using the electronic sensor system. Embodiments may also include automatically sensing the baseline cooling die temperature using the electronic sensor system. Embodiments may also include automatically adjusting input parameters including the baseline bacterial proteins dry feed rate, the baseline water feed rate, the baseline shaft speed of the barrel system, and the baseline cooling die temperature as a function of the automatic and dynamic bacterial proteins high moisture extrusion (HME) feedback loop, the automatic and dynamic bacterial proteins high moisture extrusion (HME) feedback loop automatically adjusting the input parameters thereby controlling the output conditions of the bacterial protein meat analog food product.

In some embodiments, the automatically adjusting the input parameters may include adjusting the baseline bacterial proteins dry feed rate to six and a half kilograms per hour. In some embodiments, the automatically adjusting the input parameters may include adjusting the baseline water feed rate to eight and two-tenths kilograms per hour. In some embodiments, the automatically adjusting the input parameters may include adjusting a ratio of the baseline bacterial proteins dry feed rate to the baseline water feed rate is between forty-five percent and fifty-five percent.

In some embodiments, the automatically adjusting the input parameters may include adjusting the baseline shaft speed to six-hundred-and-seventy revolutions per minute. In some embodiments, the automatically adjusting the input parameters may include adjusting the baseline cooling die temperature to ninety degrees Celsius. In some embodiments, the barrel system may also include a first barrel zone and a second barrel zone.

In some embodiments, the operations for the automatic and dynamic bacterial proteins high moisture extrusion (HME) feedback loop upon executing the processor-executable instructions may also include, automatically sensing a first temperature at the first barrel zone and a second temperature at the second barrel zone. In some embodiments, the automatically adjusting the input parameters may also include automatically adjusting the first temperature at the first barrel zone and the second temperature at the second barrel zone. In some embodiments, the first temperature at the first barrel zone is one-hundred-and-fifteen degrees Celsius and the second temperature at the second barrel zone is one-hundred-and-thirty-five degrees Celsius.

Embodiments of the present disclosure may also include a method for high moisture extrusion (HME) of bacterial proteins to make meat analog food products, the method including automatically sensing, using an electronic sensor system, a baseline bacterial proteins dry feed rate of feeding bacterial proteins into a high moisture extrusion (HME) system, the high moisture extrusion (HME) system using an automatic and dynamic bacterial proteins high moisture extrusion (HME) feedback loop for controlling output conditions of a bacterial protein meat analog food product.

Embodiments may also include automatically sensing, using the electronic sensor system, a baseline water feed rate of feeding water into the high moisture extrusion (HME) system. Embodiments may also include automatically sensing, using the electronic sensor system, a baseline shaft speed of a barrel system of the high moisture extrusion (HME) system. Embodiments may also include automatically sensing, using the electronic sensor system, a baseline cooling die temperature of a cooling die of the high moisture extrusion (HME) system. Embodiments may also include automatically adjusting input parameters including the baseline bacterial proteins dry feed rate, the baseline water feed rate, the baseline shaft speed of the barrel system, and the baseline cooling die temperature as a function of an automatic and dynamic bacterial proteins high moisture extrusion (HME) feedback loop, the automatic and dynamic bacterial proteins high moisture extrusion (HME) feedback loop automatically adjusting the input parameters thereby controlling the output conditions of the bacterial protein meat analog food product.

In some embodiments, the automatically adjusting the input parameters may include adjusting the baseline bacterial proteins dry feed rate to six and a half kilograms per hour. In some embodiments, the automatically adjusting the input parameters may include adjusting the baseline water feed rate to eight and two-tenths kilograms per hour. In some embodiments, the automatically adjusting the input parameters may include adjusting a ratio of the baseline bacterial proteins dry feed rate to the baseline water feed rate is between forty-five percent and fifty-five percent.

In some embodiments, the automatically adjusting the input parameters may include adjusting the baseline shaft speed to six-hundred-and-seventy revolutions per minute. In some embodiments, the automatically adjusting the input parameters may include adjusting the baseline cooling die temperature to ninety degrees Celsius. Embodiments may also include automatically sensing a first temperature at a first barrel zone and a second temperature at a second barrel zone. In some embodiments, the automatically adjusting the input parameters may also include automatically adjusting the first temperature at the first barrel zone and the second temperature at the second barrel zone.

In some embodiments, the automatically adjusting the input parameters may include the first temperature at the first barrel zone is one-hundred-and-fifteen degrees Celsius and the second temperature at the second temperature at the second barrel zone is one-hundred-and-thirty-five degrees Celsius. Embodiments may also include automatically sensing, using the electronic sensor system, a total throughput of the high moisture extrusion (HME) system. In some embodiments, the input parameters may also include the total throughput of the high moisture extrusion (HME) system. In some embodiments, the automatically adjusting the input parameters may also include adjusting the total throughput of the high moisture extrusion (HME) system to fifteen kilograms per hour.

Embodiments of the present disclosure may also include a method for high moisture extrusion (HME) of bacterial proteins to make meat analog food products, the method including automatically sensing, using an electronic sensor system, a baseline bacterial proteins dry feed rate of feeding bacterial proteins into a high moisture extrusion (HME) system, the high moisture extrusion (HME) system using an automatic and dynamic bacterial proteins high moisture extrusion (HME) feedback loop for controlling output conditions of a bacterial protein meat analog food product.

Embodiments may also include automatically sensing, using the electronic sensor system, a baseline water feed rate of feeding water into the high moisture extrusion (HME) system. Embodiments may also include automatically sensing, using the electronic sensor system, a baseline shaft speed of a barrel system of the high moisture extrusion (HME) system. Embodiments may also include automatically sensing, using the electronic sensor system, a baseline cooling die temperature of a cooling die of the high moisture extrusion (HME) system. Embodiments may also include automatically sensing, using the electronic sensor system, a total throughput of the high moisture extrusion (HME) system. Embodiments may also include automatically adjusting input parameters, the input parameters including the baseline bacterial proteins dry feed rate, the baseline water feed rate, the baseline shaft speed of the barrel system, and the baseline cooling die temperature, and the total throughput of the high moisture extrusion (HME) system as a function of an automatic and dynamic bacterial proteins high moisture extrusion (HME) feedback loop, the automatic and dynamic bacterial proteins high moisture extrusion (HME) feedback loop automatically adjusting the input parameters thereby controlling the output conditions of the bacterial protein meat analog food product.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a system for high moisture extrusion (HME) of bacterial proteins to make meat analog food products, according to various embodiments of the present technology.

FIG. 2 shows using an automatic and dynamic bacterial proteins high moisture extrusion (HME) feedback loop for controlling output conditions of a bacterial protein meat analog food product, according to various embodiments of the present technology

FIG. 3 illustrates a table preferred input parameters for a system for high moisture extrusion (HME) of bacterial proteins to make meat analog food products, according to various embodiments of the present technology.

FIG. 4 is a table of components of bacterial proteins used with a system for high moisture extrusion (HME) to make meat analog food products, according to various embodiments of the present technology.

FIG. 5 a continuation of the table of components of bacterial proteins used with a system for high moisture extrusion (HME) to make meat analog food products, according to various embodiments of the present technology.

FIG. 6 is a table of amino acid components of bacterial proteins used with a system for high moisture extrusion (HME) to make meat analog food products, according to various embodiments of the present technology.

FIG. 7 an exemplary method for high moisture extrusion (HME) of bacterial proteins to make meat analog food products, according to various embodiments of the present technology.

FIG. 8 is a diagrammatic representation of an example machine in the form of a computer system, according to various embodiments of the present technology.

### DESCRIPTION OF EXEMPLARY EMBODIMENTS

High moisture extrusion (HME) is a processing technology used across various industries including the food industry for producing protein food products. A problem in the food industry is some protein sources for producing protein food products are viewed negatively by consumers of the food products. For example, soy protein may be viewed negatively by some consumers. HME may be carried out by using an extruder. Thus, there is a need in the food industry to develop the HME extrusion process for a new protein source that is sustainable, has a high nutrition value for consumers, and has melting properties that allow texturization in the extrusion process. For example, bacterial proteins may be sustainable produced, may have a high nutrition value for consumers, and may have melting properties that allow for texturization in the extrusion process. For example, bacterial proteins include any proteins that are produced by bacteria. Presently very little has been done to develop bacterial proteins for the HME extrusion process. Therefore, there is a need to develop bacterial proteins for the HME extrusion process to develop an alternative protein source for meat analog food products.

In various embodiments the present technology solves the problem of developing the HME extrusion process using bacterial proteins including using an automatic and dynamic bacterial proteins high moisture extrusion (HME) feedback loop for controlling output conditions of a bacterial protein meat analog food product.

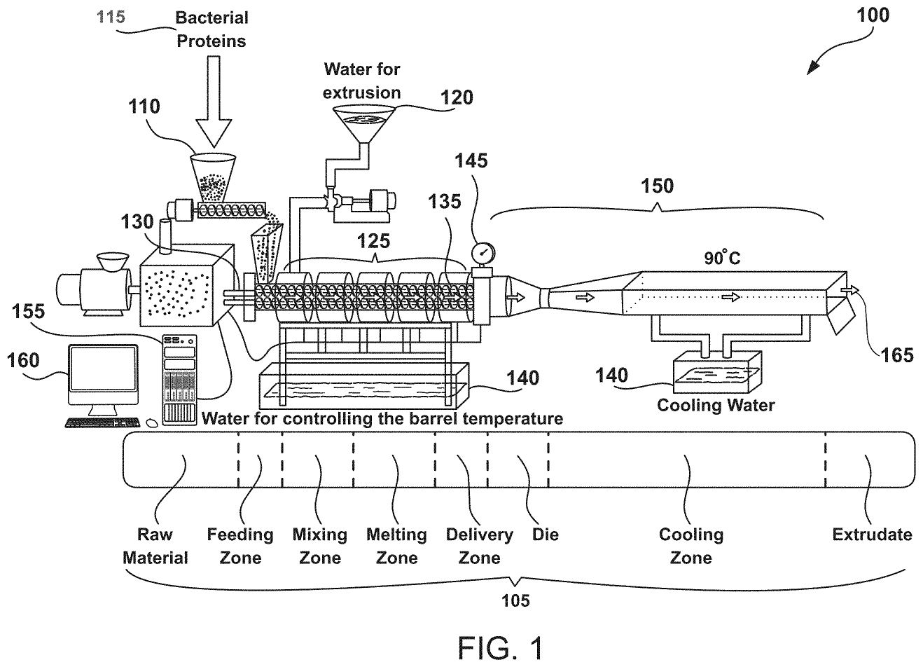

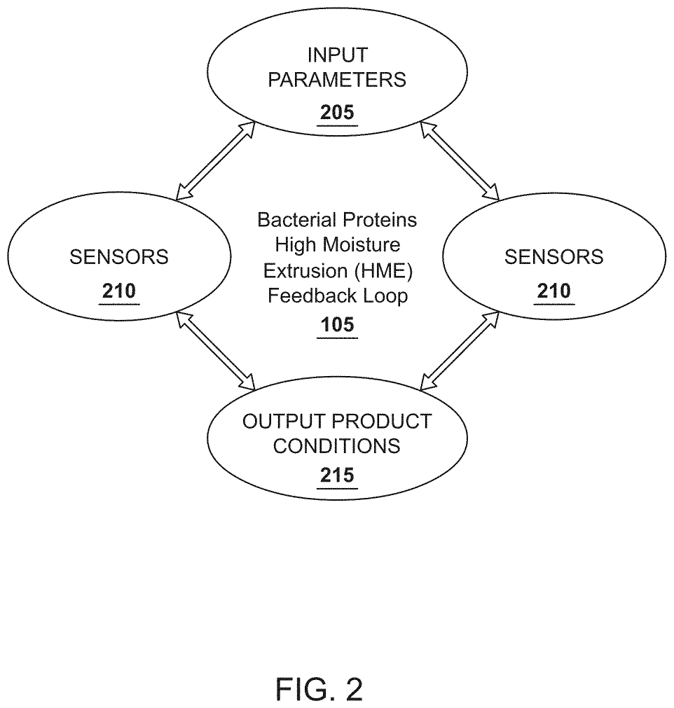

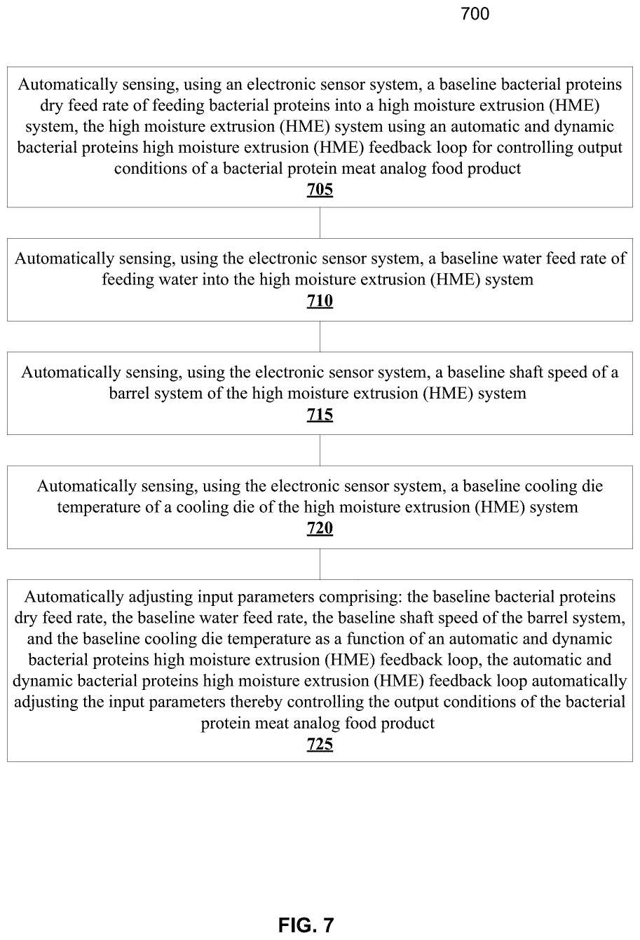

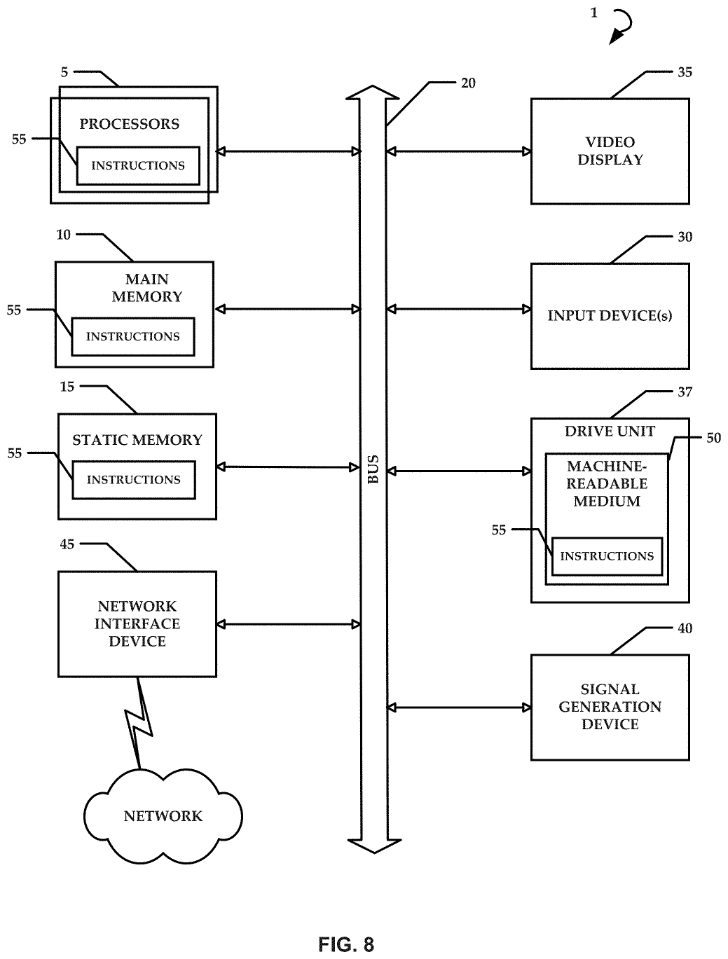

FIG. 1 is a system for high moisture extrusion (HME) of bacterial proteins to make meat analog food products, according to various embodiments of the present technology. For example, FIG. 1 shows a high moisture extrusion (HME) system 100 including using an automatic and dynamic bacterial proteins high moisture extrusion (HME) feedback loop 105 for controlling output conditions of a bacterial protein meat analog food product. In various embodiments the high moisture extrusion (HME) system 100 may comprise a dry feed system 110, the dry feed system 110 feeding bacterial proteins 115 into the high moisture extrusion (HME) system 100 at a baseline bacterial proteins dry feed rate and a water feed system 120, the water feed system 120 feeding water into the high moisture extrusion (HME) system 100 at a baseline water feed rate. The high moisture extrusion (HME) system 100 may further comprise a barrel system 125, the barrel system 125 comprising: a shaft 130 moving at a baseline shaft speed; at least one screw 135 controlled by the shaft 130; and a heating system 140; and a cooling die 150, the cooling die 150 being maintained at a baseline cooling die temperature by the heating system 140. The high moisture extrusion (HME) system 100 may also comprise an electronic sensor system, the electronic sensor system 145 (e.g., including a pressure gauge) electronically connected to the dry feed system 110, the water feed system 120, the barrel system 125, and the cooling die 150; and a main operation panel 155, the main operation panel 155 being electronically connected to the electronic sensor system 145. In various embodiments the electronic sensor system 145 includes instrumentation of the high moisture extrusion (HME) system 100 that measures process-related variables and provides accurate and timely input to the operator which can be used for making decisions about adjustments to the process using the main operation panel 155 that is electronically connected to the electronic sensor system 145. For example, some instrumentation of the electronic sensor system 145 provides basic information such as temperature, pressure, speed, flow rates, and power input to the extrusion process. Higher-level information and process-critical parameters such as specific energy input (i.e., mechanical, and thermal), retention time, moisture content, and mixing intensity is provided via variable measurement and subsequent calculations based on those measurements accomplished in an accompanying computerized systems (e.g., the computing system shown in FIG. 8 connected with the main operation panel 155). Additionally, properties of both the raw materials and resulting extrudate 165 (e.g., a meat analog food products made from bacterial proteins 115) may be measured either directly or indirectly to provide process input and output information to the operator. The properties measured will depend on the process and nearly always include bulk density, moisture, and other composition information. The main operation panel 155 may comprise a computer system 160 (e.g., computing system shown in FIG. 8). For example, the main operation panel 155 may comprise at least one processor; and a memory storing processor-executable instructions, wherein the at least one processor is configured to implement the following operations for the automatic and dynamic bacterial proteins high moisture extrusion (HME) feedback loop 105 upon executing the processor-executable instructions. Exemplary parameters of the automatic and dynamic bacterial proteins high moisture extrusion (HME) feedback loop 105 are shown in FIG. 2 that control output product conditions of the extrudate 165 (e.g., a meat analog food products made from bacterial proteins 115). Additionally, exemplary operations of the automatic and dynamic bacterial proteins high moisture extrusion (HME) feedback loop 105 are shown in FIG. 7.

FIG. 2 shows parameters for using an automatic and dynamic bacterial proteins high moisture extrusion (HME) feedback loop 105 for controlling output conditions 215 of a bacterial protein meat analog food product (e.g., the extrudate 165 of the high moisture extrusion (HME) system 100), according to various embodiments of the present technology. FIG. 2 shows automatically adjusting input parameters 205. For example, input parameters 205 may include the baseline bacterial proteins dry feed rate (e.g., feed rate of bacterial proteins 115 using dry feed system 110), the baseline water feed rate (e.g., using water feed system 120), the baseline shaft speed (i.e., baseline shaft speed of shaft 130) of the barrel system 125, and the baseline cooling die temperature (e.g., baseline temperature of the cooling die 150). Sensors 210 may automatically sense the input parameters 205 including the baseline bacterial proteins dry feed rate (e.g., feed rate of bacterial proteins 115 using dry feed system 110), the baseline water feed rate (e.g., using water feed system 120), the baseline shaft speed of the barrel system (i.e., baseline shaft speed of shaft 130), and the baseline cooling die temperature (e.g., baseline temperature of the cooling die 150). electronic sensor system 145. In various embodiments, the sensors 210 include the electronic sensor system 145 that comprises instrumentation of the high moisture extrusion (HME) system 100 which measures process-related variables and provides accurate and timely input to the operator which can be used for making decisions about adjustments to the process using the main operation panel 155 that is electronically connected to the electronic sensor system 145. The automatic and dynamic bacterial proteins high moisture extrusion (HME) feedback loop 105 may automatically adjust the input parameters 205 thereby controlling the output conditions 215 of the bacterial protein meat analog food product (e.g., the extrudate 165 being meat analog food products made from bacterial proteins 115).

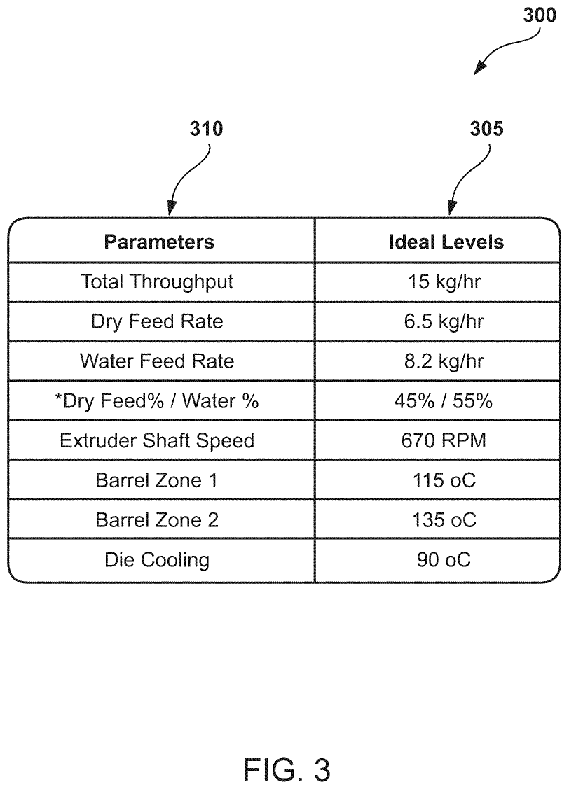

FIG. 3 illustrates a table 300 of ideal level(s) 305 of parameter(s) 310 (e.g., ideal levels of input parameters 205 as a starting point) for a system for high moisture extrusion (HME) of bacterial proteins to make meat analog food products, according to various embodiments of the present technology. For example, an ideal level(s) 305 of parameter(s) 310 (e.g., input parameters 205) may be a starting point to optimize conditions for using high moisture extrusion (HME) of bacterial proteins to make meat analog food products (e.g., the extrudate 165 of the high moisture extrusion (HME) system 100 being meat analog food products made from bacterial proteins 115). For example, the ideal level(s) 305 of parameter(s) 310 (e.g., input parameters 205) may include adjusting the baseline bacterial proteins dry feed rate (e.g., feed rate of bacterial proteins 115 using dry feed system 110) to six and a half kilograms per hour. For example, the ideal level(s) 305 of parameter(s) 310 (e.g., input parameters 205) may also include adjusting the baseline water feed rate (e.g., using water feed system 120), to eight and two-tenths kilograms per hour. For example, the ideal level(s) 305 of parameter(s) 310 (e.g., input parameters 205) may further include adjusting a ratio of the baseline bacterial proteins dry feed rate (e.g., feed rate of bacterial proteins 115 using dry feed system 110) to the baseline water feed rate (e.g., using water feed system 120) to be between forty-five percent and fifty-five percent. For example, the ideal level(s) 305 of parameter(s) 310 (e.g., input parameters 205) may include adjusting the baseline shaft speed (i.e., baseline shaft speed of shaft 130) to six-hundred-and-seventy revolutions per minute. For example, the ideal level(s) 305 of parameter(s) 310 (e.g., input parameters 205) may also include adjusting the baseline cooling die temperature (e.g., baseline temperature of the cooling die 150) to ninety degrees Celsius. For example, the ideal level(s) 305 of parameter(s) 310 (e.g., input parameters 205) may further include the first temperature at the first barrel zone (e.g., temperature of the barrel system 125) being one-hundred-and-fifteen degrees Celsius and the second temperature at the second temperature at the second barrel zone (e.g., temperature of the barrel system 125) is one-hundred-and-thirty-five degrees Celsius. In some embodiments, total throughput of the high moisture extrusion (HME) system 100 is calculated using values related to the system pressure, dimensions of the extruder and properties of the material being extruding (e.g., bacterial proteins 115). In some embodiments, total extrusion throughput is calculated by subtracting the volumetric pressure flow of the high moisture extrusion (HME) system 100 from the volumetric drag flow. For example, the ideal level(s) 305 of parameter(s) 310 (e.g., input parameters 205) may include adjusting the total throughput to fifteen kilograms per hour.

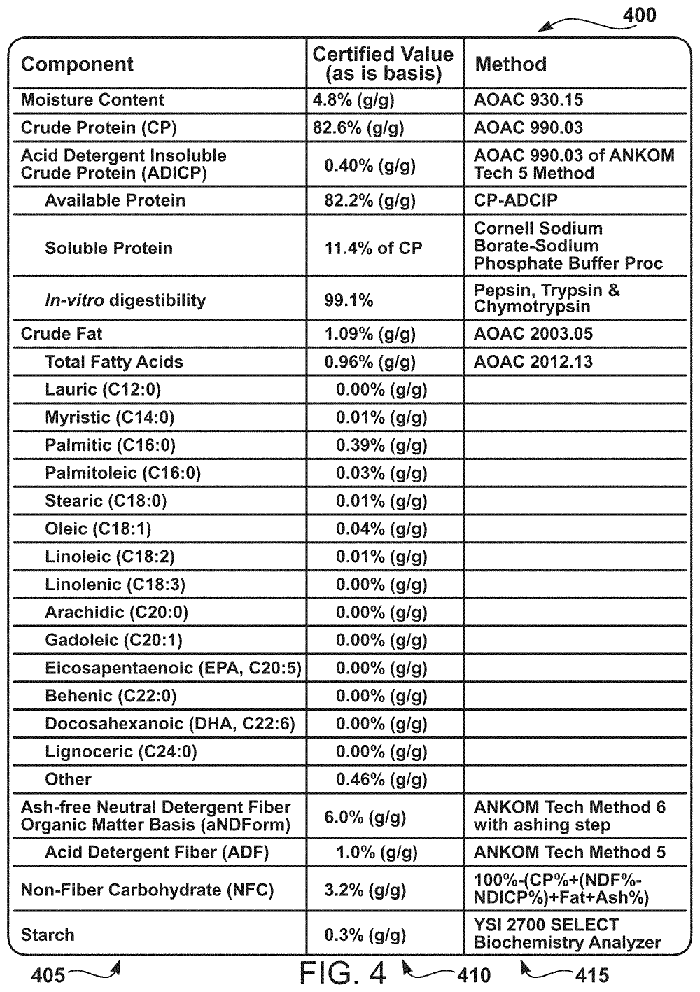

FIG. 4 is a table 400 of components of bacterial proteins used with a system for high moisture extrusion (HME) to make meat analog food products, according to various embodiments of the present technology. For example, table 400 shows exemplary bacterial proteins 115 that may be used with the high moisture extrusion (HME) system 100 including using the automatic and dynamic bacterial proteins high moisture extrusion (HME) feedback loop 105. FIG. 4 shows three columns of table 400 including component column 405 of bacterial proteins 115, certified value column 410 of bacterial proteins 115, and method column 415 (i.e., method of production of a component of bacterial proteins 115). For example, method column 415 (i.e., method of production of a component of bacterial proteins 115) includes references to methods of the Association of Official Agricultural Chemists (AOAC). Official Methods of Analysis (OMA) is a publication of AOAC comprised of more than three-thousand validated methods. Official Methods of Analysis (OMA) is one of the most comprehensive and reliable collection of chemical and microbiological methods and consensus standards available to a person of ordinary skill in the art.

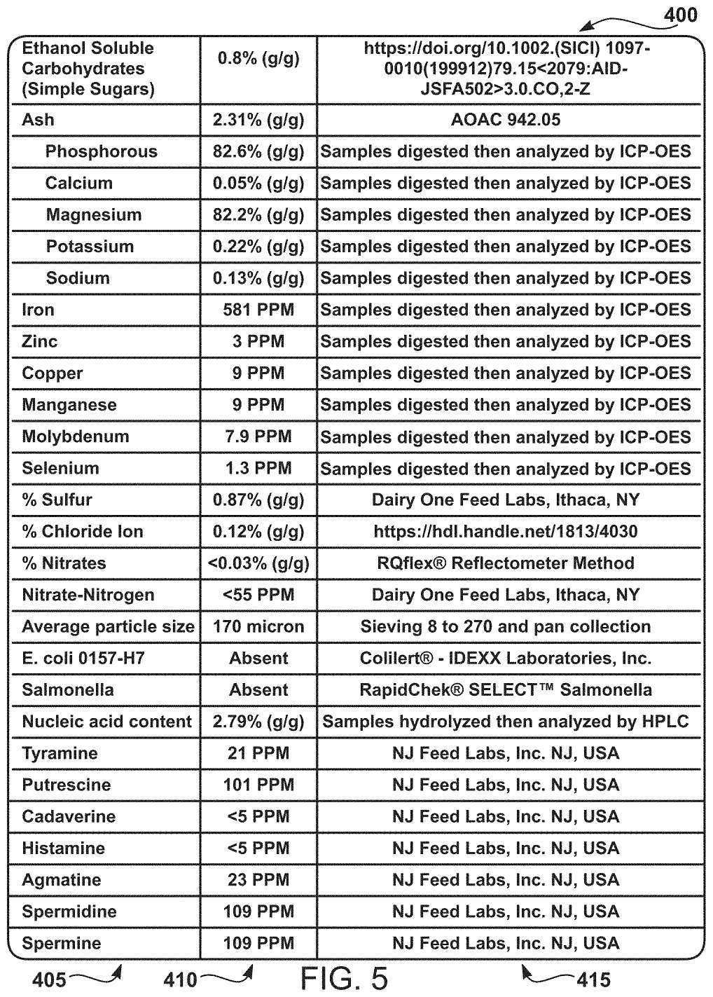

FIG. 5 a continuation of the table 400 of components of bacterial proteins used with a system for high moisture extrusion (HME) to make meat analog food products, according to various embodiments of the present technology. FIG. 4 shows a continuation of three columns of table 400 including component column 405 of bacterial proteins 115, certified value column 410 of bacterial proteins 115, and method column 415 (i.e., method of production of a component of bacterial proteins 115). For example, FIG. 5 shows a continuation of table 400 displaying a characterization of exemplary bacterial proteins 115 that may be used with the high moisture extrusion (HME) system 100 including using the automatic and dynamic bacterial proteins high moisture extrusion (HME) feedback loop 105.

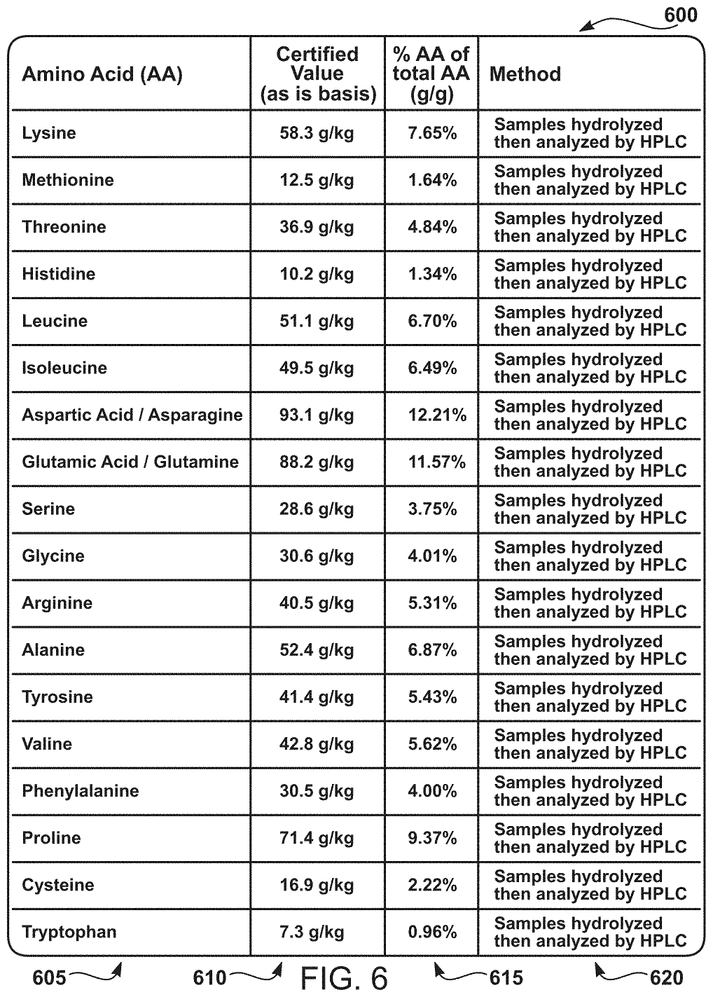

FIG. 6 is a table 600 of amino acid components of bacterial proteins used with a system for high moisture extrusion (HME) to make meat analog food products, according to various embodiments of the present technology. FIG. 6 lists amino acid components in four columns of table 600 for bacterial proteins 115. For example, FIG. 6 the four columns of table 600 include an amino acid column 605, a certified value of bacterial proteins column 610, a percentage of total amino acids column 615 (e.g., a percentage of an ammino acid of the total amount of amino acids of the bacterial proteins 115), and method column 620 (i.e., method of analysis of the amino acid). For example, lysine has a certified value of 58.3 grams per kilogram, and the amino acid lysine is 7.65 percent (g/g) of the total amino acids of the bacterial proteins 115 (e.g., a percentage of an ammino acid of the total amount of amino acids of the bacterial proteins 115). Furthermore, the method of analyzing lysine is hydrolyzing the sample of bacterial proteins 115 and then analyzed using High-Performance Liquid Chromatography (HPLC). For example, table 400 shows exemplary bacterial proteins 115 that may be used with the high moisture extrusion (HME) system 100 including using the automatic and dynamic bacterial proteins high moisture extrusion (HME) feedback loop 105.

FIG. 7 an exemplary method for high moisture extrusion (HME) of bacterial proteins to make meat analog food products, according to various embodiments of the present technology. For example, FIG. 7 shows an exemplary method that may be used for bacterial proteins 115 (as described in FIG. 4, FIG. 5, and FIG. 6) as the input for the high moisture extrusion (HME) system 100 including using the automatic and dynamic bacterial proteins high moisture extrusion (HME) feedback loop 105. FIG. 7 shows an exemplary method according to some embodiments of the present disclosure. According to FIG. 7, embodiments may include a method for high moisture extrusion (HME) of bacterial proteins to make meat analog food products, the method including 705 through 725 using an electronic sensor system (e.g., electronic sensor system 145). In some embodiments the electronic sensor system 145 includes instrumentation of the high moisture extrusion (HME) system 100 that measures process-related variables and provides accurate and timely input to the operator which can be used for making decisions about adjustments to the process using the main operation panel 155 that is electronically connected to the electronic sensor system 145. For example, some instrumentation of the electronic sensor system 145 provides basic information such as temperature, pressure, speed, flow rates, and power input to the extrusion process. Higher-level information and process-critical parameters such as specific energy input (i.e., mechanical, and thermal), retention time, moisture content, and mixing intensity is provided via variable measurement and subsequent calculations based on those measurements accomplished in an accompanying computerized systems (e.g., the computing system shown in FIG. 8 connected with the main operation panel 155). Additionally, properties of both the raw materials and resulting extrudate 165 (e.g., meat analog food products made from bacterial proteins 115) may be measured either directly or indirectly to provide process input and output information to the operator. The properties measured will depend on the process and nearly always include bulk density, moisture, and other composition information.

At 705, the method may include automatically sensing using an electronic sensor system (e.g., electronic sensor system 145), a baseline bacterial proteins dry feed rate of feeding bacterial proteins into a high moisture extrusion (HME) system (e.g., feed rate of bacterial proteins 115 using dry feed system 110), the high moisture extrusion (HME) system 100 using an automatic and dynamic bacterial proteins high moisture extrusion (HME) feedback loop 105 for controlling output conditions of a bacterial protein meat analog food product (e.g., the extrudate 165 being meat analog food products made from bacterial proteins 115). For example, the baseline bacterial proteins dry feed rate may be higher or lower than eight and six-and-half kilograms per hour.

At 710, the method may include automatically sensing, using the electronic sensor system (e.g., the electronic sensor system 145 and accompanying instrumentation of the high moisture extrusion (HME) system 100), a baseline water feed rate (e.g., using water feed system 120) feeding water into the high moisture extrusion (HME) system 100. For example, the baseline water feed rate may be higher or lower than eight and two-tenths kilograms per hour.

At 715, the method may include automatically sensing, using the electronic sensor system (e.g., the electronic sensor system 145 and accompanying instrumentation of the high moisture extrusion (HME) system 100), a baseline shaft speed (i.e., baseline shaft speed of shaft 130) of a barrel system 125 of the high moisture extrusion (HME) system 100. For example, the baseline shaft speed rate may be higher or lower than six-hundred-and-seventy revolutions per minute.

At 720, the method may include automatically sensing, using the electronic sensor system (e.g., the electronic sensor system 145 and accompanying instrumentation of the high moisture extrusion (HME) system 100), a baseline cooling die temperature of a cooling die of the high moisture extrusion (HME) system. For example, the cooling die temperature may be higher or lower than ninety degrees Celsius.

At 725, the method may include automatically adjusting input parameters comprising: the baseline bacterial proteins dry feed rate (e.g., feed rate of bacterial proteins 115 using dry feed system 110), the baseline water feed rate (e.g., using water feed system 120), the baseline shaft speed (i.e., baseline shaft speed of shaft 130) of the barrel system 125, and the baseline cooling die temperature (e.g., baseline temperature of the cooling die 150) as a function of an automatic and dynamic bacterial proteins high moisture extrusion (HME) feedback loop 105, the automatic and dynamic bacterial proteins high moisture extrusion (HME) feedback loop 105 automatically adjusting the input parameters thereby controlling the output conditions of the bacterial protein meat analog food product (e.g., the extrudate 165, the meat analog food products made from bacterial proteins 115). For example, in some embodiments the automatic and dynamic bacterial proteins high moisture extrusion (HME) feedback loop 105 automatically adjusts the parameter to the ideal level(s) 305 of parameter(s) 310 (e.g., input parameters 205) to optimize conditions for using high moisture extrusion (HME) of bacterial proteins to make meat analog food products. In various embodiments the present technology uses artificial intelligence for automatically adjusting the input parameters for controlling the output conditions of the bacterial protein meat analog food product (e.g., the extrudate 165, the meat analog food products made from bacterial proteins 115).

FIG. 8 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiments in many different forms, there is shown in the drawings and has been described in detail several specific embodiments with the understanding that the present disclosure is to be considered as an exemplification of the principles of the technology and is not intended to limit the technology to the embodiments illustrated.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer, or section. Thus, a first element, component, region, layer, or section discussed below could be termed a second element, component, region, layer, or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

The description of the present disclosure has been presented for purposes of illustration and description but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A system for high moisture extrusion (HME) of bacterial proteins to make meat analog food products, the system comprising:
a high moisture extrusion (HME) system including using an automatic and dynamic bacterial proteins high moisture extrusion (HME) feedback loop for controlling output conditions of a bacterial protein meat analog food product, the high moisture extrusion (HME) system comprising:
a dry feed system, the dry feed system feeding bacterial proteins into the high moisture extrusion (HME) system at a baseline bacterial proteins dry feed rate;
a water feed system, the water feed system feeding water into the high moisture extrusion (HME) system at a baseline water feed rate;
a barrel system, the barrel system comprising:
a shaft moving at a baseline shaft speed;
at least one screw controlled by the shaft; and
a heating system; and
a cooling die, the cooling die being maintained at a baseline cooling die temperature by the heating system;
an electronic sensor system, the electronic sensor system electronically connected to the dry feed system, the water feed system, the barrel system, and the cooling die; and
a main operation panel, the main operation panel being electronically connected to the electronic sensor system, the main operation panel comprising:
at least one processor; and
a memory storing processor-executable instructions, wherein the at least one processor is configured to implement the following operations for the automatic and dynamic bacterial proteins high moisture extrusion (HME) feedback loop upon executing the processor-executable instructions:
automatically sensing the baseline bacterial proteins dry feed rate of the bacterial proteins using the electronic sensor system;
automatically sensing the baseline water feed rate using the electronic sensor system;
automatically sensing the baseline shaft speed using the electronic sensor system;
automatically sensing the baseline cooling die temperature using the electronic sensor system; and
automatically adjusting input parameters comprising: the baseline bacterial proteins dry feed rate, the baseline water feed rate, the baseline shaft speed of the barrel system, and the baseline cooling die temperature as a function of the automatic and dynamic bacterial proteins high moisture extrusion (HME) feedback loop, the automatic and dynamic bacterial proteins high moisture extrusion (HME) feedback loop automatically adjusting the input parameters thereby controlling the output conditions of the bacterial protein meat analog food product.

2. The system of claim 1, wherein the automatically adjusting the input parameters comprises adjusting the baseline bacterial proteins dry feed rate to six and a half kilograms per hour.

3. The system of claim 1, wherein the automatically adjusting the input parameters comprises adjusting the baseline water feed rate to eight and two-tenths kilograms per hour.

4. The system of claim 1, wherein the automatically adjusting the input parameters comprises adjusting a ratio of the baseline bacterial proteins dry feed rate to the baseline water feed rate is between forty-five percent and fifty-five percent.

5. The system of claim 1, wherein the automatically adjusting the input parameters comprises adjusting the baseline shaft speed to six-hundred-and-seventy revolutions per minute.

6. The system of claim 1, wherein the automatically adjusting the input parameters comprises adjusting the baseline cooling die temperature to ninety degrees Celsius.

7. The system of claim 1, wherein the barrel system further comprises a first barrel zone and a second barrel zone.

8. The system of claim 7, wherein the operations for the automatic and dynamic bacterial proteins high moisture extrusion (HME) feedback loop upon executing the processor-executable instructions further comprise:
automatically sensing a first temperature at the first barrel zone and a second temperature at the second barrel zone.

9. The system of claim 8, wherein the automatically adjusting the input parameters further comprises automatically adjusting the first temperature at the first barrel zone and the second temperature at the second barrel zone.

10. The system of claim 9, wherein the first temperature at the first barrel zone is one-hundred-and-fifteen degrees Celsius and the second temperature at the second barrel zone is one-hundred-and-thirty-five degrees Celsius.

11. A method for high moisture extrusion (HME) of bacterial proteins to make meat analog food products, the method comprising:
automatically sensing, using an electronic sensor system, a baseline bacterial proteins dry feed rate of feeding bacterial proteins into a high moisture extrusion (HME) system, the high moisture extrusion (HME) system using an automatic and dynamic bacterial proteins high moisture extrusion (HME) feedback loop for controlling output conditions of a bacterial protein meat analog food product;
automatically sensing, using the electronic sensor system, a baseline water feed rate of feeding water into the high moisture extrusion (HME) system;
automatically sensing, using the electronic sensor system, a baseline shaft speed of a barrel system of the high moisture extrusion (HME) system;
automatically sensing, using the electronic sensor system, a baseline cooling die temperature of a cooling die of the high moisture extrusion (HME) system; and
automatically adjusting input parameters comprising: the baseline bacterial proteins dry feed rate, the baseline water feed rate, the baseline shaft speed of the barrel system, and the baseline cooling die temperature as a function of an automatic and dynamic bacterial proteins high moisture extrusion (HME) feedback loop, the automatic and dynamic bacterial proteins high moisture extrusion (HME) feedback loop automatically adjusting the input parameters thereby controlling the output conditions of the bacterial protein meat analog food product.

12. The method of claim 11, wherein the automatically adjusting the input parameters comprises adjusting the baseline bacterial proteins dry feed rate to six and a half kilograms per hour.

13. The method of claim 11, wherein the automatically adjusting the input parameters comprises adjusting the baseline water feed rate to eight and two-tenths kilograms per hour.

14. The method of claim 11, wherein the automatically adjusting the input parameters comprises adjusting a ratio of the baseline bacterial proteins dry feed rate to the baseline water feed rate is between forty-five percent and fifty-five percent.

15. The method of claim 11, wherein the automatically adjusting the input parameters comprises adjusting the baseline shaft speed to six-hundred-and-seventy revolutions per minute.

16. The method of claim 11, wherein the automatically adjusting the input parameters comprises adjusting the baseline cooling die temperature to ninety degrees Celsius.

17. The method of claim 11, further comprising:
automatically sensing a first temperature at a first barrel zone and a second temperature at a second barrel zone;
wherein the automatically adjusting the input parameters further comprises automatically adjusting the first temperature at the first barrel zone and the second temperature at the second barrel zone.

18. The method of claim 17, wherein the automatically adjusting the input parameters comprises the first temperature at the first barrel zone is one-hundred-and-fifteen degrees Celsius and the second temperature the second temperature at the second barrel zone is one-hundred-and-thirty-five degrees Celsius.

19. The method of claim 11, further comprising:
automatically sensing, using the electronic sensor system, a total throughput of the high moisture extrusion (HME) system;
wherein the input parameters further comprise the total throughput of the high moisture extrusion (HME) system;
wherein the automatically adjusting the input parameters further comprises adjusting the total throughput of the high moisture extrusion (HME) system to fifteen kilograms per hour.

20. A method for high moisture extrusion (HME) of bacterial proteins to make meat analog food products, the method comprising:
automatically sensing, using an electronic sensor system, a baseline bacterial proteins dry feed rate of feeding bacterial proteins into a high moisture extrusion (HME) system, the high moisture extrusion (HME) system using an automatic and dynamic bacterial proteins high moisture extrusion (HME) feedback loop for controlling output conditions of a bacterial protein meat analog food product;
automatically sensing, using the electronic sensor system, a baseline water feed rate of feeding water into the high moisture extrusion (HME) system;
automatically sensing, using the electronic sensor system, a baseline shaft speed of a barrel system of the high moisture extrusion (HME) system;
automatically sensing, using the electronic sensor system, a baseline cooling die temperature of a cooling die of the high moisture extrusion (HME) system;
automatically sensing, using the electronic sensor system, a total throughput of the high moisture extrusion (HME) system;
automatically adjusting input parameters, the input parameters comprising the baseline bacterial proteins dry feed rate, the baseline water feed rate, the baseline shaft speed of the barrel system, and the baseline cooling die temperature, and the total throughput of the high moisture extrusion (HME) system as a function of an automatic and dynamic bacterial proteins high moisture extrusion (HME) feedback loop, the automatic and dynamic bacterial proteins high moisture extrusion (HME) feedback loop automatically adjusting the input parameters thereby controlling the output conditions of the bacterial protein meat analog food product.
